(19) United States
(12) Patent Application Publication
(10) Pub. No.: US 2012/0080882 A1
(43) Pub. Date: Apr. 5, 2012

(54) Electric generator utilizing high pressure fluid spray to rotate power generating

(76) Inventor: Kenneth Tyrone Newburn, Lucedale, MS (US)

(21) Appl. No.: 12/924,644

(22) Filed: Oct. 4, 2010

(51) Int. Cl. H02K 7/18; F03B 17/04

(52) U.S. Cl. 290/52; 415/916

(57) ABSTRACT

The inventor presents a new generator utilizing a new method to rotate power generating mechanisms within comprising a prior art a/c permanent magnet alternator affixed atop a cylindrical housing having its central rotor shaft penetrating down through central aperture through tank top within tank. A rotor wheel is coupled to rotor shaft to aid in rotor rotation. The new method to rotate said rotor wheel further comprises a fluid pump whereby fluid is pulled from the bottom of tank through a tank outlet port and returned through tank inlet port at the top of tank wherein a high pressure fluid tip having a small aperture in center is further coupled within tank. When spent fluid is pulled from tank bottom through pump it is then forced through the high pressure tip causing a high velocity spray to be repelled at rotor wheel reacting with rotor wheel blades causing rotor to spin creating usable electricity. The present invention when operating creates more usable electricity than is needed to run the fluid pump, but cannot operate on its own without a outside source of power to operate pump. Once the generator is operational, the electricity created can be used to charge a bank of batteries or extend the battery life of batteries charged by a wind turbine or solar panels. The power can also be used to power a home or sold back to the utility company. The generator is meant to be used wherever an extra energy source is needed.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

This invention relates to a electricity producing generator, and this invention further relates to wind turbine produced electricity, and more specifically this invention is a generator utilizing a fluid pump to create high pressure fluid spray, to spin a redesigned rotor wheel of a prior art wind turbine a/c alternator, to produce usable electricity.

In the world today there are many methods for producing electricity such as wind power, hydro power and thermal power. Hydro power is energy derived from moving water, such as the electricity produced from hydroelectric dams. Water pressurized from gravity is run through a turbine which in turn spins a rotor producing electrical energy from the generator. This method for producing electricity has been very successful and has very few drawbacks since the dam used for a hydro power plant also creates reservoirs for recreation, drinking water, irrigation, and flood control.

Wind power is energy derived from the direct force of wind, such as the electricity produced from a wind turbine. The wind turns the blades, the blade spins the shaft, the shaft connects to the generator, producing usable electricity. A problem with this method of producing usable electricity is its reliance on wind force to generate this usable electricity. No wind, no electricity. Another drawback to wind power is the inability to control the wind force against rotor blades to create optimum electricity output from the generator. On some days the wind blows too fast on other days too slow, this causes a fluctuation in power output.

A thermal power station uses thermal power, or steam, as its prime mover to create electricity. Water is heated, turns into steam, and spins a steam turbine which drives an electric generator to produce electricity. This method also has its draw backs. To keep up with the demand of an ever growing world population, more and more fossil fuels are being used, depleting the world supply, and causing global warming from the pollution burning fossil fuels emit. All of these prior art methods have one thing in common, they all use some type of force to rotate a rotor within a generator, to create usable energy. This new invention is a electricity producing generator utilizing a prior art permanent magnet wind turbine a/c alternator with a redesigned rotor wheel, and a new method for applying force to a rotor wheel to produce rotation. The new force applied is high pressure fluid spray created by a forced fluid pumped through a small aperture of a high pressure tip.

### BRIEF SUMMERY OF INVENTION

This present invention is a new method for creating usable electricity, but is intended to be used in conjunction with today's prior art energy methods, such as utility power, solar power, wind power, and hydro power, because this new invention requires one of these prior art energy methods to become operational, and will assist one or the other usable prior art energy methods in creating more usable energy. Once becoming operational this new invention does produce more usable electricity than is needed from the outside source to operate pump. This higher electricity output is made possible because of advances in wind turbine generator technology. Past prior art wind turbine technologies utilized a d/c power generator that relied on a geared rotor to increase rpm of generator to achieve the generators rated power capacity because d/c generators require a high rpm to produce electricity. D/C generators further use brushes that contact copper strips on the rotating shaft within said generator. These brushes produce drag which in turn along with the said gears aid in slowing rotation of said past generator. This present invention utilizes a newer wind turbine technology. This said technology is a a/c alternator that is a gearless, brushless, direct drive generator, utilizing neodymium permanent magnets to produce its rated power capacity at a low rpm. This new technology a/c alternator further has a low cogging and resistive torque design, and utilizes full contact sealed bearings, has a low start up speed, and can be positioned with central shaft either horizontal or vertical up or vertical down.

This present invention though comprising a a/c alternator used in wind turbine technology, is not a wind turbine, but a new technology utilizing a fluid pump to produce high pressure fluid spray, as the force whereby rotor wheel rotates a permanent magnet alternator. This new invention further overcomes some of the inefficiencies of a wind turbine, while still designed to work in conjunction with the wind turbine to fix some of the inefficiencies. A wind turbine only produces usable electricity when enough wind is blowing to force the rotor blades into motion. The present invention has removed the hub and blade assembly from a wind turbine alternator and replaced it with a rotor wheel. A 110 volt fluid pump is then utilized to force pressurized fluid through a small aperture centered through a high pressure tip. The forced fluid is then repelled from the tip at a very high velocity making contact with the rotor wheel forcing rotation of wheel thus creating usable electricity without wind force.

Another inefficiency of the wind turbine is its inability to maintain a constant rotor speed for maximum wattage output of generator, due to changing wind speeds. The present invention overcomes this inefficiency by adding a voltage regulator in pumping system to adjust the pump voltage either up or down to control the fluid spray force contacting the rotor wheel further controlling the rotors rpm. A valve is further added between the fluid pump and the high pressure tip as a backup for the voltage regulator. This system allows the alternator to be rotated at a constant rpm, thus allowing for a constant maximum wattage output from generator. A example of how this present invention can be used along with a wind turbine generator to overcome some of its inefficiencies, is by utilizing the present invention on days when the wind turbine has not created any usable electricity due to lack of wind force. Since this new invention operates on 110 volts and can create 1500 watts or more of usable electricity, the d/c batteries of the non producing wind turbine electrical system can be converted to a/c to power the present invention, thus turning the 110 volts to operate the fluid pump and the only electricity being pulled from batteries, into 1500 watts of usable electricity to be distributed where needed, therefore using less of the batteries stored electricity, and invariably some of this electricity could be fed back through wind turbine electrical system to recharge the same batteries supplying the 110 volts to the pump of the present invention. The present invention can use this same means of operation to extend the batteries used in solar power technology or could be plugged into a utility source to reduce electricity consumption from the utility source to lower electrical bills or to sell excess electricity back to the utility company, or to create an extra energy source if extra electricity is needed, or affixed to solar or wind system as a permanent part of its electricity producing system. This new generator is meant to be employed wherever a power source is available to operate its pumping system, wherever additional power is required.

### BRIEF DESCRIPTION OF SEVERAL VIEWS OF THE DRAWINGS

For a better understanding of the preferred embodiments and the scope of the new generators desired employment a description of several views of the drawings whereby is shown that:

FIG. 1 is a plan view showing the preferred embodiments of working generator.

FIG. 2 is a detailed plan view showing the many possibilities for electricity input and output.

FIG. 3 is a tank sectional view with parts broken away to show the method within for producing usable electricity.

FIG. 4 is a plan view of fluid holding with tank outlined with a broken line for a clear view of its inner components and its outer components.

FIG. 5 is a top view of fluid holding tank showing a shaft seal centered in top of tank.

FIG. 6 is a plan view of the arrow dynamic rotor wheel showing forced spray repelled at rotor wheel to force rotation.

FIG. 7 is a top view of the arrow dynamic rotor wheel showing blade diagram around circumference of rod.

FIG. 8 is a diagram of rotor wheels rotation.

### DETAILED DESCRIPTION OF THE INVENTION

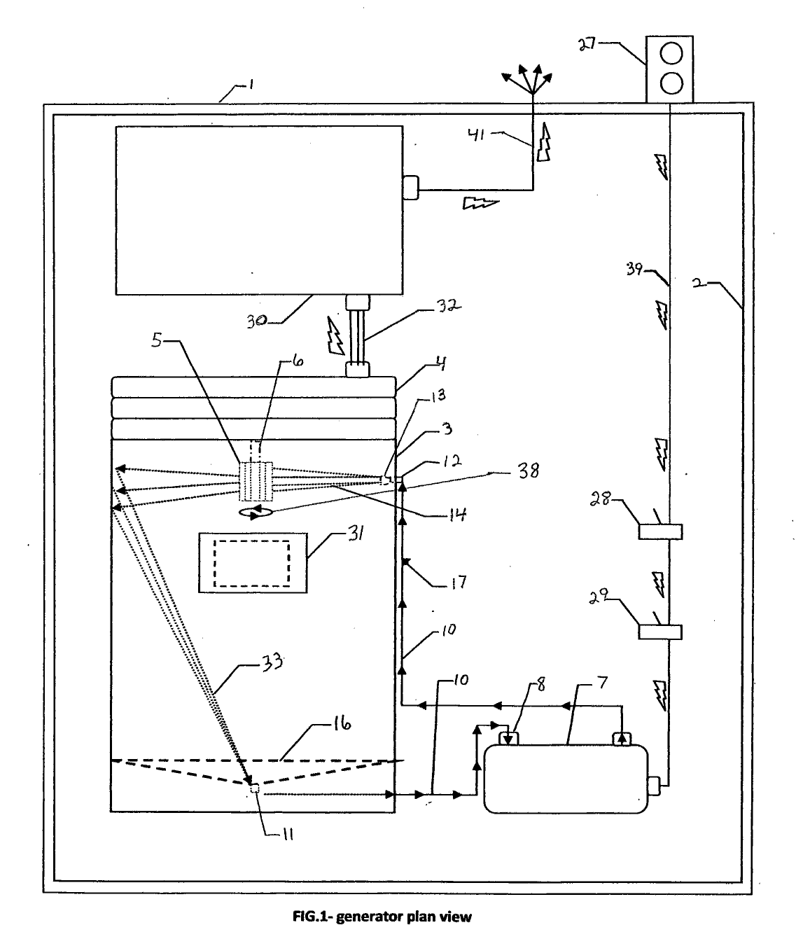

Preferred embodiments of the present invention and its desired means of employment are best described by referring to FIG. 1-8 of the drawings, in which like numerals refer to like parts.

FIG. 1 illustrates the plan view of the preferred embodiments of the “ELECTRIC GENERATOR UTILIZING HIGH PRESSURE FLUID SPRAY TO ROTATE POWER PRODUCING MECHANISMS”1.

FIG. 1 further illustrates a operational a/c fluid pump 7 connected to a outside source for a 110v power source 27 having a prior art pump off and on switch 28 and a prior art voltage regulator 29 within wiring system 39.

FIG. 1 further illustrates a fluid holding tank 3 having a prior art a/c alternator 4 affixed on top having its central rotor shaft 6 penetrating through a central aperture in tanks 3 top.

FIG. 1 further illustrates a access 40 with a clear access cover 31 to view inside or work on mechanisms within tank.

FIG. 1 further illustrates the method for containing spent fluid 33 and circulating spent fluid 33 back to the fluid pump 7, comprising a tank 3 for containing spent fluid 33 having a funneling 16 means whereby spent fluid 33 is forced down to bottom of tank 3 by gravitational pull into funnel 16, then pulled through a tank outlet drain port 11 through a rigid tube 10 into pump inlet port 8 wherein fluid is further pumped back into tank inlet port 12 to be utilized for prior art a/c alternator 4 rotation.

FIG. 1 further illustrates the new rotor wheel 5 coupled to rotor shaft 6 within tank 3.

FIG. 1 further shows the method utilized for rotating rotor shaft 6 of prior art a/c alternator 4 further comprising a operational fluid pump 7 pulling spent fluid 33 from bottom of tank through tank outlet port 11 and circulating fluid back into tank inlet port 12 wherein a high pressure tip 13 is further coupled to tank inlet port 12 within tank 3. The pumped spent fluid 33 is forced through a small aperture in center of tip 13, creating a high velocity repelled fluid spray 14 that then reacts with rotor wheel 5 forcing the rotor to spin 38.

FIG. 1 further shows control panel box 30 accepting electricity from prior art a/c alternator 4 then redistributing electricity outside of generator 41.

FIG. 1 further shows the framed housing 2 containing all the components that make up the present new electric generator 1.

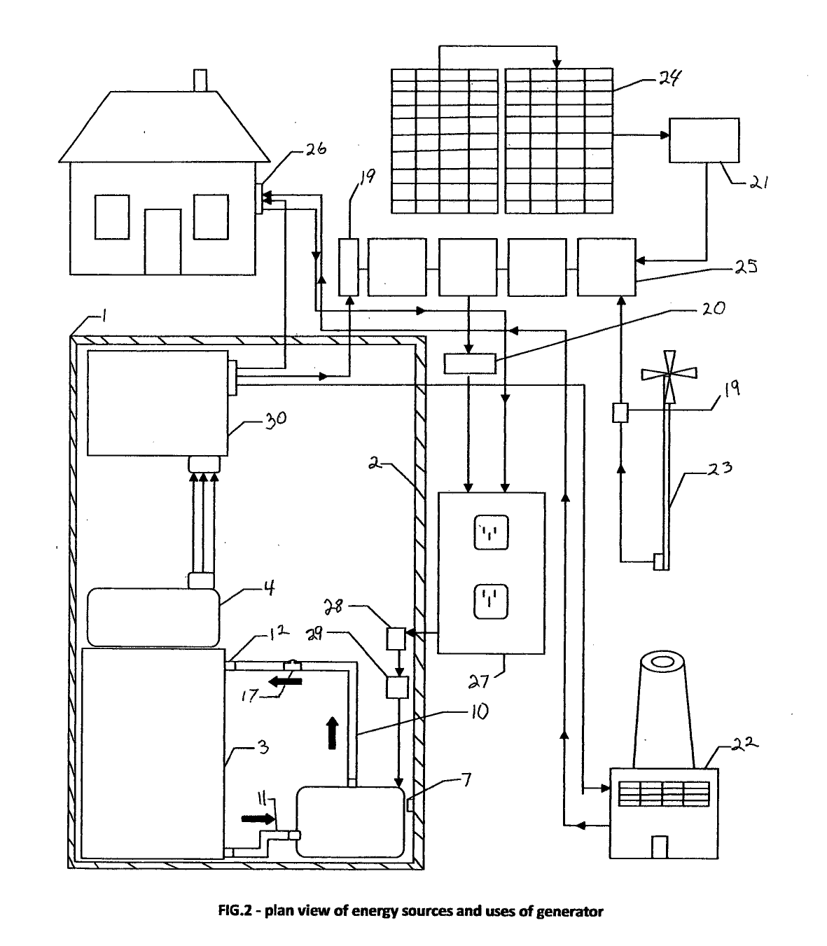

FIG. 2 illustrates some of the ways the present invention 1 can receive usable electricity such as connecting 110v a/c power 27 to the new generators 1 fluid pump 1 from various outside sources such a utility company 22, a wind turbine 23, or solar power 24.

FIG. 2 further illustrates the need for an outside source to operate electricity producing mechanisms within new generator 1, and some of the ways the present invention can utilized in conjunction along with today's prior art technologies such as being connected along with either a solar power system 24, 25, 21, 20 and 27, or a wind turbine power system 23, 19, 25, 20 and 27, to aid in producing power on days of little or no power production. The present illustration further provides a example of how generated electricity can be distributed from the new generator 1. The examples given include home power 26 use, and converting a/c to d/c 19 for battery pack 25 recharging, and routing electricity back to utility company 22.

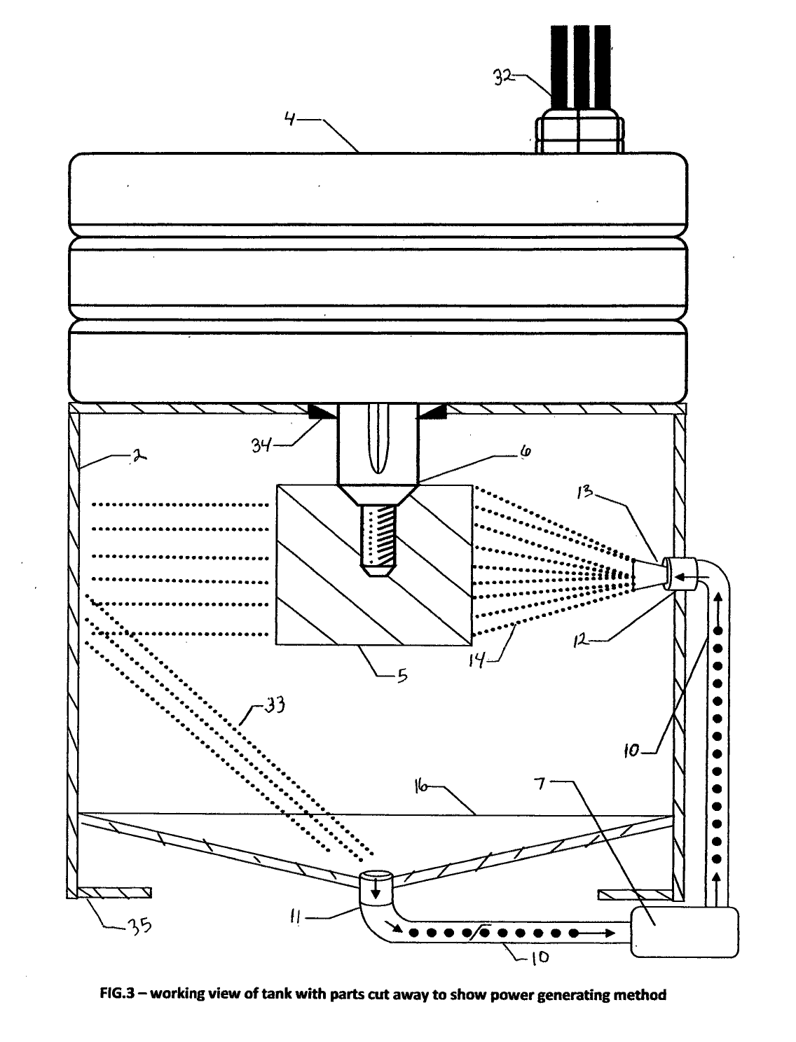

FIG. 3 illustrates a rigid holding tank 2 with parts broken away to view inside working components having a prior art, a/c, direct drive, low rpm, gearless, three phase, permanent magnet alternator 4 affixed on top with alternators central rotor shaft 6 positioned through a central aperture within tank wherein a flexible seal 34 is affixed flexing around rotor shaft 6 for keeping spent fluid within tank 2. Said rotor shaft 6 further has a threaded end whereon a rotor wheel 5 is coupled. The view of the rotor wheel 5 is further broken away to show the coupling of rotor shaft 6 threaded end and rotor wheel 5.

FIG. 3 further shows a method for forcing the rotation of the rotor wheel 5 and creating usable electricity. The said method further comprises a high pressure fluid pump 7 whereby spent fluid 33 is funneled through a tank outlet drain port 11 through a hollow tube 10 into inlet side of pump 8, through pump 7, and out through pump outlet port 9 again through hollow tube 10 further coupled to tank inlet port 12. A high pressure tip 13 is further coupled to tank inlet port 12 within tank 2 wherein the pumped fluid 33 is forced through a small aperture in center of high pressure tip 13 creating a high pressure fluid spray 14 that is expelled from high pressure tip 13 at a high velocity reacting with rotor wheel blades of 36, forcing the rotor wheel 5 to spin.

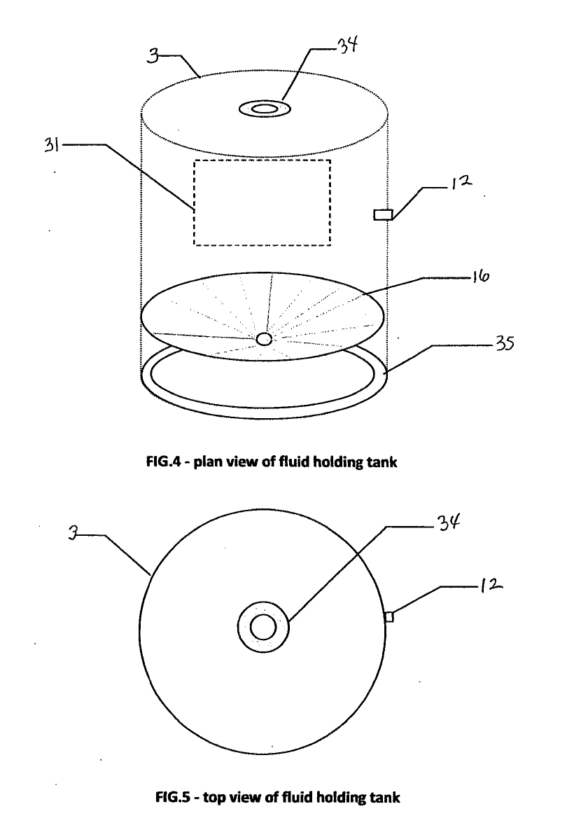

FIG. 4 further shows a plan view of the fluid holding tank 3 showing its inside working components including a funnel 16, a access hole with its clear cover 31, 40, a bottom mounting flange 35, a tank top inlet port 12 and rubber seal 34 in tops center.

FIG. 5 further shows a top view of fluid holding tank 3 with a clear view of the rotor shaft seal 34 position.

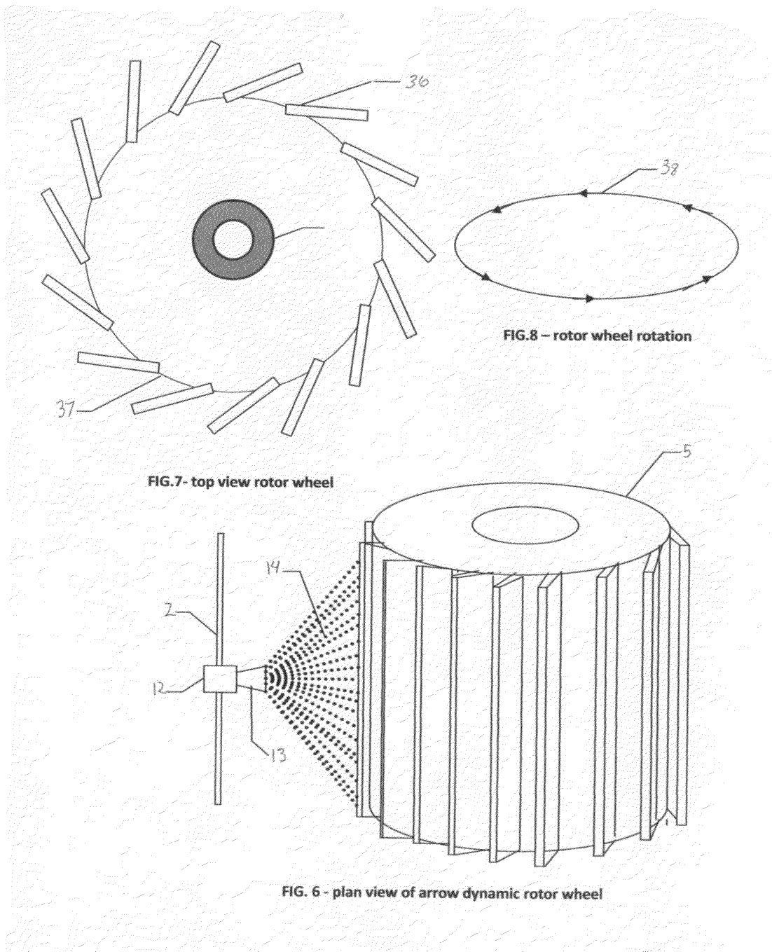

FIG. 6 illustrates the working dynamics of the rigid rotor wheel 5 and how the angled rotor wheel blades 36 capture the expelled spray 14 to begin rotor wheel rotation 38.

FIG. 7 illustrates the preferred embodiments of the said rotor wheel 5

FIG. 7 further illustrates the top view of the rigid rotor wheel 5 and shows the plural rotor wheel blades affixed around a rigid cylindrical rod 36, being angled in towards rigid cylindrical rod 36 at a degree which best captures expelled spray 14 and arrow dynamics during rotation 38.

FIG. 8 illustrates the rotation of the rotor wheel 38 during operation.

Although the embodiments of the system and the method of the present invention have been illustrated in the accompanying drawings and described in the foregoing detailed description, it will be understood that the invention is not limited to the embodiments disclosed, but is capable of numerous modifications, rearrangements, substitutions, fabrications, base metals and base materials, without departing from the spirit of the invention as set forth and defined by the following claims.

What is claimed is new and desired to be protected by Letters Patent:

1. A electric generator utilizing high pressure fluid spray to rotate power generating mechanisms comprising:
(a) a rigid framed housing for containing on or within all the components of this new invention; and (b) a fluid holding tank affixed within said framed housing; and (c) a prior art operable, direct drive, gearless, low rpm, permanent magnet, three phase a/c alternator, capable of turning mechanical energy into electricity, is affixed to top outside circumference of said fluid holding tank, positioned on a horizontal plane to the ground, having its central rotor shaft penetrating down through a circular aperture through tank top, substantially aligned with tanks central axis, and further having rotor shaft positioned within tank substantially parallel to tanks inner walls; and (d) a arrow dynamic rotor wheel coupled to end of said central rotor shaft of prior art a/c alternator within tank, further providing a means to rotate rotor of said prior art a/c alternator to actuate electricity producing mechanisms within said a/c alternator, by capturing expelled high pressure fluid spray to produce rotation of rotor; (e) a method affixed within framed housing to create said high pressure fluid spray the force used to rotate rotor of said a/c alternator to produce usable electricity, further comprising: a prior art electric fluid pump, having a inlet and a outlet port for pulling fluid in, and pushing fluid out, a hollow tube is coupled at one end to inlet port of fluid pump, and at other end to tank outlet drain port centrally positioned in bottom of fluid tank, a second hollow tube is coupled to fluid outlet port of pump at one end, and fluid tank inlet port at other end, having both coupled ends to tank top, and bottom, penetrating through tank to inside cavity, a prior art high pressure fluid spray tip is further coupled inside tank to fluid tank inlet port, and when electricity is applied to electric pump, fluid is pulled from the tank bottom through hollow tube into pump inlet port, then further pushed through pump outlet port through hollow tube, and forced through aperture in high pressure tip causing forced high pressure fluid spray to expel from high pressure tip and impact with arrow dynamic wheel, further causing a forced rotation of rotor, and further having spent fluid spray captured by tank walls, and funneled back through the pumping system by gravitational pull; and (F) a means to control the fluid spray force expelled against arrow dynamic wheel to adjust said prior art alternators rotors rpm for optimum electricity production during operation, further comprising: a voltage regulator within fluid pumps electrical system, to make fluid pump run faster, or slower, to control fluid pressure force protruding against arrow dynamic roller, controlling rpm of inside electrical producing mechanisms of said prior art a/c alternator and a valve within fluid supply system to further control fluid pressure entering high pressure tip and; (g) a control panel box having all the prior art components to except the electricity expelled from a operational generators prior art alternator safely, and a means to further distribute the expelled electricity from new generator to a outside source safely, and a further a means to operate generator safely; and (h) a means to cool said new generator comprising a prior art low voltage fan and a duct system, to pull cool air in and push hot air out of framed housing.

2. A electric generator utilizing high pressure fluid spray to rotate power generating mechanisms of claim 1 (b), wherein said rigid tank is cylindrical in form, having a flat top end, and a cone shaped bottom end, having central vertex of cone pointing substantially downward; said tank is further affixed within said framed housing, having tanks central axis substantially perpendicular to horizontal plane of ground; said tank further comprises a circular aperture through center of tank top wherein a flexible seal is positioned, whereby said shaft of generator can be positioned within tank, and no fluid can leak out; said tank further comprises a circular aperture through tank bottoms central vertex where in a coupling is positioned, whereby spent fluid can be recycled back into fluid pumping system; said tank further comprises a means to view the components within tank cavity comprising: a clear rigid access cover molded to the contour of the outside circumference of tank shell, and further affixed to outside circumference of tank shell over a established opening through tank shell, for viewing working components inside tank.

3. The electric generator utilizing high pressure fluid spray to rotate power generating mechanisms of claim 1(c), wherein said prior art a/c alternator does produce more electricity than the electricity exhumed from a outside power source to operate fluid pump and cooling system.
The electric generator utilizing high pressure fluid spray to rotate power generating mechanisms of claim 1(c) wherein the prior art a/c alternator is not limited to any particular size, shape, or wattage when utilized in the present scope of the new generators intended use.

4. A electric generator utilizing high pressure fluid spray to rotate power generating mechanisms of claim 1(d), wherein said arrow dynamic rotor wheel is comprised of a rigid cylindrical rod having a threaded circular cavity at one end for coupling with threaded central shaft of said prior art generator, and further having plural rigid straight rectangular blades affixed from one even plane to the other even plane of rod, and radiating evenly spaced around outside circumference of rod, and further having blades being substantially parallel with central axis of rigid cylindrical rod and inside walls of tank, and still further having blades leaning in towards outside circumference of rod at a degree sufficient to best capture expelled high pressure fluid spray on one side of blade, and arrow dynamics on the other side of blade, during rotation, and even further said arrow dynamic rollers has an axis of rotation substantially perpendicular with central axis of tank, and is positioned within tank at a substantial distance from tank walls, for ease of rotation and fluid dispersion.

5. The electric generator utilizing high pressure fluid spray to rotate power generating mechanisms of claim 1(e), wherein the said electric fluid pump can accept any form of usable electricity within its present scope for operation, to become operational, including; utility power, wind power, solar power, hydro power, or the like.

6. The electric generator utilizing high pressure fluid spray to rotate power generating mechanisms of claim 1(e), wherein a single method to produce high pressure fluid spray, to rotate a single prior art brushless, gearless, direct drive, permanent magnet, operable a/c alternator, can be adapted to rotate plural said prior art a/c alternators, to produce more usable electricity within the present scope of this new generators intended means of operation.

7. The electric generator utilizing high pressure fluid spray to rotate power generating mechanisms of claim 1(e), wherein said fluid pump is not limited to any particular size, shape, or voltage when utilized within the scope of the new inventions intended means of operation.

8. The electric generator utilizing high pressure fluid spray to rotate power generating mechanisms of claim 1(e), wherein said fluid pump utilized to operate power generating method can also be a d/c pump when utilized within the scope of this new generators intended means of operation.

9. The electric generator utilizing high pressure fluid spray to rotate power generating mechanisms of claim 1(e), wherein said method of using a pump, to force high pressure fluid through a aperture in a high pressure tip, to expel high pressure fluid spray, the force utilized in this new invention to spin rotor of said prior art a/c alternator, is new in the art of power generation.
